(19) United States
(12) Patent Application Publication
(10) Pub. No.: US 2006/0001310 A1
(43) Pub. Date: Jan. 5, 2006

(54) Multi-leaded lug bolt for accelerated wheel removal and attachment

(76) Inventors: Douglas E. Crafts, Los Gatos, CA (US); Steve M. Swain, San Jose, CA (US); Duane S. Cook, San Jose, CA (US); Gilbert R. Rothweiler, Santa Cruz, CA (US)

Correspondence Address: HESLIN ROTHENBERG FARLEY & MESITI PC, 5 COLUMBIA CIRCLE, ALBANY, NY, 12203, US

(21) Appl. No.: 11/171,930

(22) Filed: Jun. 30, 2005

Related U.S. Application Data
(60) Provisional application No. 60/585,500, filed on Jul. 2, 2004.

(51) Int. Cl. B60B 1/00

(52) U.S. Cl. 301/35.621

(57) ABSTRACT

A lug bolt adapted for use on an automobile having at least a double lead to decrease the number turns a lug nut requires to screw the lug nut onto the lug bolt. The lug bolt may comprise a triple or quadruple lead, or even more leads. A racing automobile may be provided having the lug bolt for the mounting of a wheel thereon using a correspondingly-leaded lug nut. The racing automobile may be a NASCAR automobile, in one embodiment.

### CROSS-REFERENCE TO RELATED APPLICATION

This application claims the benefit of U.S. Provisional Application No. 60/585,500, filed Jul. 2, 2004, which is hereby incorporated herein by reference in its entirety.

### TECHNICAL FIELD

The present invention relates in general to automobile wheel attachment techniques. In particular, the present invention relates to multi-leaded lug bolts and nuts for accelerated wheel removal and attachment during time-sensitive events, i.e., during an automobile race.

### BACKGROUND OF THE INVENTION

Automobile wheel attachment and removal under most conditions is a mundane and tedious task, usually performed only when wheel maintenance or emergencies exist. In such scenarios, removal and attachment time is only one factor out of many to be considered. Only rarely does wheel change time become a factor—possibly during a highway emergency under adverse conditions—with a driver who is under duress. Even under these conditions the wheel change time can be measured in minutes or tens of minutes; and improvements can be measured in single minutes or tens of seconds.

With reference to FIGS. 1A and 1B, during an automobile race 10, wheel change times can be a critical path during pit stops 12 which themselves are measured in single seconds—e.g., about 10-20 seconds total or less. Changing 2 or 4 wheels (14, 16) within this time is often required—and improvements in wheel change times measured in single seconds or fractions of seconds are highly desirable.

NASCAR races are commonly won or lost over tenths of a second differences in pit times. Pit times are typically between 13 to 15 seconds, with teams varying only by about a second during any given race day. Therefore, reduction in pit stop times is an essential factor in such races.

What is required, therefore, is a technique, including an apparatus and method, for accelerating wheel removal and attachment, optimized for automobile racing events.

### SUMMARY OF THE INVENTION

The shortcomings of the prior art are overcome and additional advantages are provided by the present invention which in one aspect is a lug bolt adapted for use on an automobile, having at least a double lead to decrease the number turns a lug nut requires to screw the lug nut onto the lug bolt. The lug bolt may have a triple or quadruple lead, or even more leads. A racing automobile may be provided having the lug bolt for the mounting of a wheel thereon using a correspondingly-leaded lug nut. The racing automobile may be a NASCAR automobile.

The racing automobile will likely have a plurality of such lug bolts, each of the lug bolts affixed to the automobile for the mounting of a plurality of wheels thereon, using a plurality of correspondingly-leaded lug nuts.

In another aspect, the present invention is a method for affixing a wheel to an automobile, including providing a lug bolt affixed to the automobile having at least a double lead; and affixing the wheel to the automobile using the lug bolt and a correspondingly-leaded lug nut. In most likely embodiments, a plurality of lug bolts are provided, each having at least a double lead; and a plurality of wheels are affixed onto the automobile using a plurality of correspondingly-leaded lug nuts.

The lug bolts may have triple or quadruple leads (or more); and the automobile in one embodiment is a NASCAR automobile.

In another aspect, the present invention is a method for fabricating a lug bolt adapted for use on an automobile, including providing a lug bolt shaft; and forming at least a double lead on the shaft to decrease the number turns a lug nut requires to screw the lug nut onto the lug bolt. Triple or quadruple leads may be formed on the shaft, and the automobile may be a racing automobile, e.g., a NASCAR racing automobile. A plurality of such lug bolts may be fabricated, each of the lug bolts affixed to the automobile for the mounting of a plurality of wheels thereon, using a plurality of correspondingly-leaded lug nuts.

These bolts and nuts can reduce pit times by as much as 1 second. 1 second can amount to as much as 20 car lengths during a NASCAR green flag pitstop (300 feet). Wheel change times during NASCAR pit stops are therefore significant factors, and any improvements are of critical importance, such as those offered by the present invention.

Further additional features and advantages are realized through the apparatus and techniques of the present invention. Other embodiments and aspects of the invention are described in detail herein and are considered a part of the claimed invention.

### BRIEF DESCRIPTION OF THE DRAWINGS

The subject matter regarded as the invention is particularly pointed out and distinctly claimed at the conclusion of the specification. The foregoing and other objects, features, and advantages of the invention are apparent from the following detailed description taken with the accompanying drawings in which:

FIG. 1A is a perspective view of an automobile race, e.g., a NASCAR race;

FIG. 1B is a perspective view of an exemplary pit stop of the automobile race of FIG. 1 during which wheels are being changed;

FIGS. 2A-C are each side and end views, respectively, of double, triple and quadruple-lead bolts and nuts according to an aspect of the present invention;

FIG. 3 shows side, top and end views of a lug bolt of the present invention optimized for a NASCAR automobile;

FIG. 4A is a perspective view of a NASCAR wheel hub having all lug nuts thereon; and

FIG. 4B is a perspective view of a NASCACR wheel hub having several lug nuts removed.

### BEST MODE FOR CARRYING OUT THE INVENTION

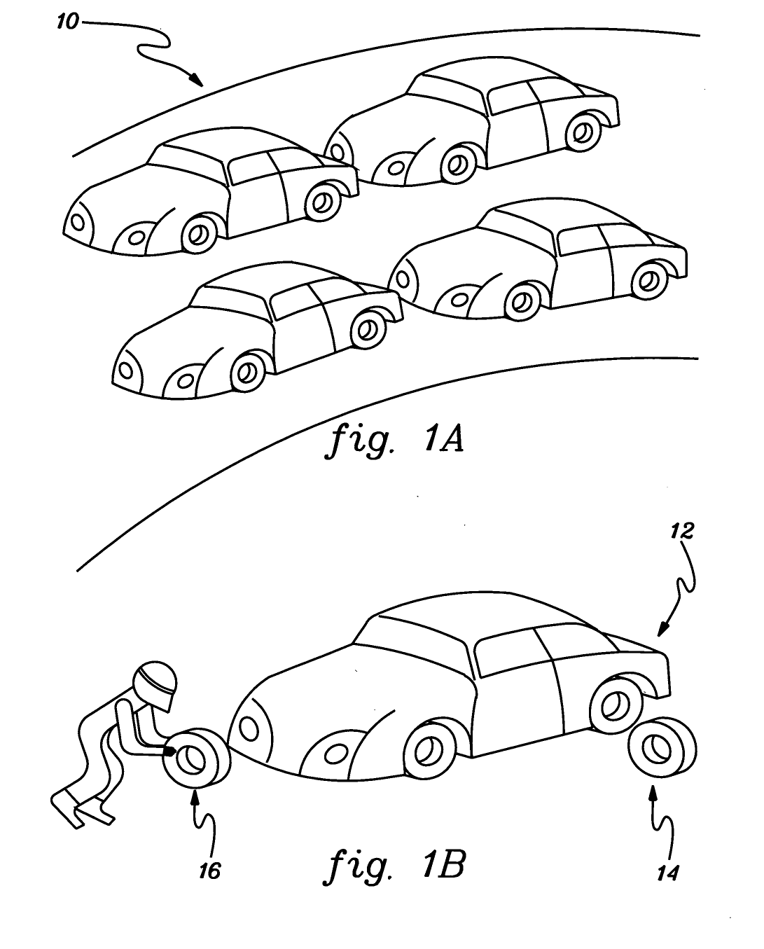

As discussed above, the present invention is directed to a method and apparatus for reducing the time required to change wheels, for example, during a pit stop in an automobile race. FIG. 1A depicts such a race 10 in which spacings between cars (and therefore victory) can be measured in fractions of a second; and FIG. 1B depicts a typical pit stop 12 during which wheels 14 and 16 are changed. Wheel change times are critical for optimizing the overall pit stop times, therefore, any improvements are critical to success.

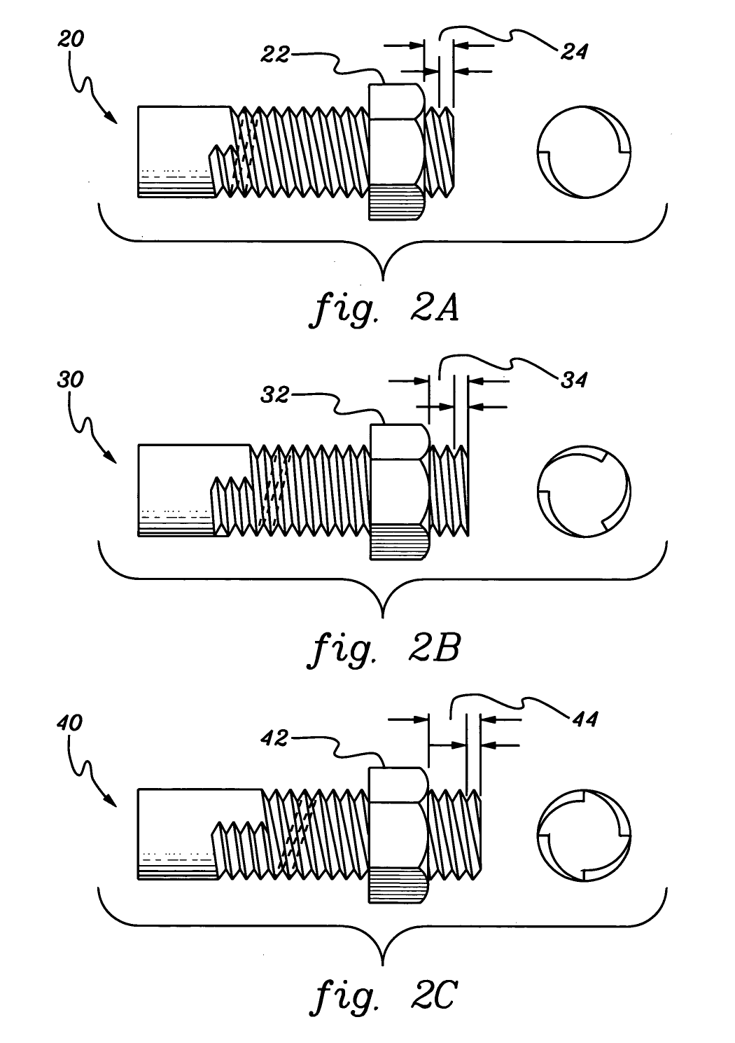

In accordance with the present invention, and with reference to FIGS. 2a-c, double, triple and quadruple-leaded lug bolts 20, 30 and 40 are depicted, along with their correspondingly-leaded lug nuts 22, 32 and 42, which together are affixed to an automobile (not shown) to reduce the time necessary to affix the nut to the bolt. The “lead” is the distance that a nut travels in one revolution. Both the “lead” and “pitch” dimensions are shown schematically as 24, 34 and 44. In one turn on a single lead bolt, a nut moves forward the distance (pitch) of one lead; in one turn on a double lead it moves twice as far; on a triple lead it moves 3 times as far, and a quadruple lead moves 4 times as far, etc. On a conventional, single lead bolt, the lead and the pitch are the same, but on a two lead screw the lead is twice the pitch. Pitch is measured the same way for single and double lead tread. It is the distance from a point on one lead to the corresponding point on the next lead. The tread depth is based on the pitch and not the lead.

Therefore, the lead of a bolt can be modified into a double, triple, etc. configuration, without changing the pitch and depth parameters (which themselves control the strength of the bond between the lug and bolt). By using a bolt with at least double leads in accordance with the present invention, the rotations of the lug nut necessary to fully affix the nut to the bolt are reduced proportionately—therefore, the time necessary to affix the nuts is also reduced. As discussed above, this technique can shave seconds, or fractions of seconds, from the overall pit stop times, thereby decreasing a team's overall finishing time in a race.

More particularly, multiple lead leads offer several advantages:
1. Number of turns to remove/install a double thread is 5, vs. 10 on a standard lead—resulting in a 2× faster replacement time over standard bolts/nuts. This will help reduce pit stop times while guaranteeing all nuts will be fully tightened with the same pre-existing thread pitch and depth.
2. They reduce the risk of cross-leaded nuts.
3. They furnish more bearing surface area than single leads.
4. They have larger minor diameters, and therefore a multi-leaded bolt can be stronger than one with a single lead.
5. They are more efficient as they lose less power to friction than do single lead leads.

Though FIGS. 2A-2C depict double, triple and quadruple leads, the present invention extends to any automobile lug nut/bolt system having more than a single lead, i.e., at least a double lead.

This technique can reduce pit times by as much as 1 second or more. One second can amount to as much as 20 car lengths during a green flag pit stop (300 feet) in a NASCAR race—which as depicted in FIG. 1 can be decided by less than a single car length.

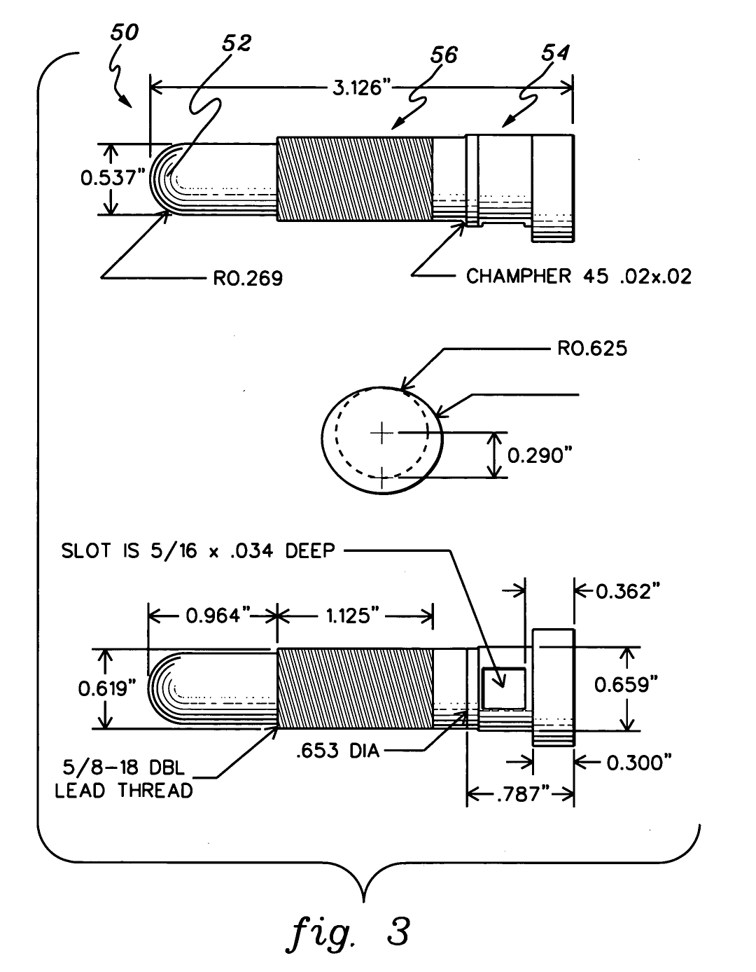

FIG. 3 depicts one embodiment 50 of the lug bolt of the present invention optimized for NASCAR automobile wheel hubs and attachment techniques, including a multi-leaded thread 56 and a rounded end 52, over which a lug bolt can be easily and quickly placed. The other end 54 of bolt 50 is specially modified to affix to a NASCAR automobile. All other relevant dimensions are depicted, as examples.

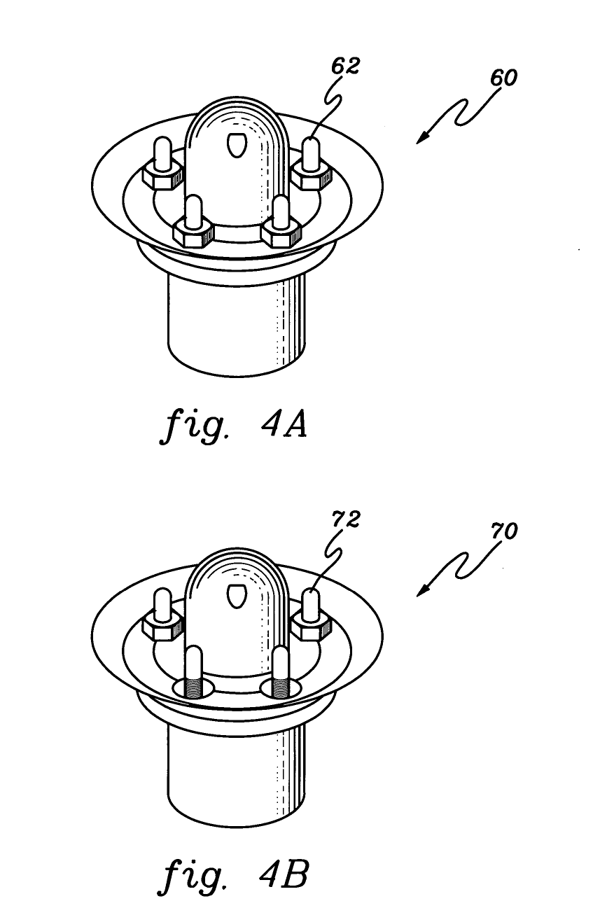

FIGS. 4A & 4B are exemplary, NASCAR automobile wheel hubs 60 and 70 having multi-leaded bolts 62, 72 affixed thereto, along with full and partial lug nut sets, respectively. For safety and interchangeability reasons, it is anticipated that all lug bolts of the same car (or all cars within the same team, or all cars within the same race) will have identical, interchangeable, lug bolts and interchangeable lug nuts.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A lug bolt adapted for use on an automobile comprising at least a double lead to decrease the number turns a lug nut requires to screw the lug nut onto the lug bolt.

2. The lug bolt of claim 1, comprising a triple or quadruple lead.

3. A racing automobile in combination with a plurality of lug bolts according to claim 2, each of the lug bolts affixed to the automobile for the mounting of a plurality of wheels thereon, using a plurality of correspondingly-leaded lug nuts.

4. A racing automobile in combination with the lug bolt of claim 2 affixed to the automobile for the mounting of a wheel thereon using a correspondingly-leaded lug nut.

5. The combination of claim 4, wherein the racing automobile comprises a NASCAR automobile.

6. A racing automobile in combination with the lug bolt of claim 1 affixed to the automobile for the mounting of a wheel thereon using a correspondingly-leaded lug nut.

7. The combination of claim 6, wherein the racing automobile comprises a NASCAR automobile.

8. A racing automobile in combination with a plurality of lug bolts according to claim 1, each of the lug bolts affixed to the automobile for the mounting of a plurality of wheels thereon, using a plurality of correspondingly-leaded lug nuts.

9. A method for affixing a wheel to an automobile, comprising:
providing a lug bolt affixed to the automobile having at least a double lead; and
affixing the wheel to the automobile using the lug bolt and a correspondingly-leaded lug nut.

10. The method of claim 9, further comprising providing a plurality of lug bolts, each having at least a double lead; and
affixing a plurality of wheels onto the automobile using a plurality of correspondingly-leaded lug nuts.

11. The method of claim 9, wherein the lug bolt comprises a triple or quadruple lead.

12. The method of claim 9, wherein the automobile comprises a NASCAR automobile.

13. A method for fabricating a lug bolt adapted for use on an automobile comprising:
providing a lug bolt shaft; and
forming at least a double lead on the shaft to decrease the number turns a lug nut requires to screw the lug nut onto the lug bolt.

14. The method of claim 13, wherein said forming comprises forming a triple or quadruple lead on the shaft.

15. A method of modifying a racing automobile in combination with the method of claim 14, comprising:
affixing a plurality of lug bolts each having at least a double lead, each of the lug bolts affixed to the automobile for the mounting of a plurality of wheels thereon, using a plurality of correspondingly-leaded lug nuts.

16. A method for modifying a racing automobile in combination with the method of claim 14, comprising:
affixing the lug nut to the automobile for the mounting of a wheel thereon using a correspondingly-leaded lug nut.

17. The combination of claim 16, wherein the racing automobile comprises a NASCAR automobile.

18. A method for modifying a racing automobile in combination with the method of claim 13, comprising:
affixing the lug nut to the automobile for the mounting of a wheel thereon using a correspondingly-leaded lug nut.

19. The combination of claim 18, wherein the racing automobile comprises a NASCAR automobile.

20. A method of modifying a racing automobile in combination with the method of claim 13, comprising:
affixing a plurality of lug bolts each having at least a double lead, each of the lug bolts affixed to the automobile for the mounting of a plurality of wheels thereon, using a plurality of correspondingly-leaded lug nuts.
